(19) United States
(12) Patent Application Publication
(10) Pub. No.: US 2010/0244817 A1
(43) Pub. Date: Sep. 30, 2010

(54) Resolver

(75) Inventors: Katsuyuki Togawa, Takahama-shi (JP); Tomoaki Inoue, Nagoya-shi (JP)

Correspondence Address: OLIFF & BERRIDGE, PLC, P.O. BOX 320850, ALEXANDRIA, VA, 22320-4850, US

(73) Assignee: AISAN KOGYO KABUSHIKI KAISHA, Obu-Shi (JP)

(21) Appl. No.: 12/659,616

(22) Filed: Mar. 15, 2010

(30) Foreign Application Priority Data
Mar. 25, 2009 (JP) 2009-073537
Feb. 15, 2010 (JP) 2010-030447

(51) Int. Cl. G01B 7/30

(52) U.S. Cl. 324/207.25

(57) ABSTRACT

A resolver includes an excitation coil, an excitation signal output circuit for outputting an excitation signal to the excitation coil, a search coil for receiving a magnetic field generated in the excitation coil, and an output signal processing circuit for processing a detection signal detected by the search coil. The resolver further includes a noise cancel circuit configured to previously detect noise from an output signal of the excitation signal output circuit and to output a cancel signal having an opposite phase to that of the noise to the output signal processing circuit.

### CROSS-REFERENCE TO RELATED APPLICATIONS

This application is based upon and claims the benefit of priority from the prior Japanese Patent Applications No. 2009-073537 filed on Mar. 25, 2009 and No. 2010-30447 filed on Feb. 15, 2010, the entire contents of which are incorporated herein by reference.

### TECHNICAL FIELD

The present invention relates to a resolver to be used for detecting the rotation angle of an output shaft of a vehicle motor.

### BACKGROUND ART

As for a hybrid electric vehicle and an electric vehicle, a high-power brushless motor is used and furthermore a higher power motor will be expected. To control the brushless motor of a hybrid electric vehicle, it is necessary to accurately ascertain the rotation angle of an output shaft of the motor. This is because the rotation position (angle) of a rotor needs to be correctly ascertained in order to control switching of energization of coils of a stator.

Accordingly, the motor preferably includes a resolver to accurately detect the angle. Such resolver used in a drive mechanism of a vehicle is required to provide high accuracy in addition to environment resistance because of the high number of revolutions of the drive mechanism. As with other in-vehicle components, the resolver is also demanded to achieve size reduction and cost reduction.

Patent Literature 1 discloses a technique to provide a resolver with compact size, reduced weight, and low cost, while achieving enhanced detection accuracy. The resolver includes an excitation winding to which an excitation signal is input and a detection winding to which a detection signal is input. The resolver is configured to detect a displacement amount of a movable element in which the excitation winding or the detection winding is provided based on a detection signal that changes according to the displacement amount of the movable element. A modulation signal formed by amplitude modulation of a high-frequency signal by the excitation signal is input to the excitation winding and also a modulation signal output from the detection winding is demodulated to produce a detection signal.

### CITATION LIST

### Patent Literature

Patent Literature 1: JP 2000-292205 A

### SUMMARY OF INVENTION

### Technical Problem

However, Patent Literature 1 has the following problems. An excitation signal is input to the excitation winding and a detection signal is output from the detection winding to an output processing circuit. The circuit contains stray capacitance and also electromagnetic induction in a harness. A component of the excitation signal is superimposed as noise on the detection signal. This may deteriorate detection accuracy. The occurrence of noise will be particularly problematic during use of a high-frequency signal.

To solve the above problems, the present invention has a purpose to provide a resolver less influenced by noise even if a high-frequency signal is used.

### Solution to Problem

To achieve the above purpose, one aspect of the present invention provides a resolver including: an excitation coil; an excitation signal output circuit for outputting an excitation signal to the excitation coil; a search coil for receiving a magnetic field generated in the excitation coil; and a detection signal processing circuit for processing a detection signal detected by the search coil (16) to calculate a position of the search coil, the resolver comprising: a noise cancel circuit configured to combine the detection signal and one of the excitation signal and a signal having an opposite phase to that of the excitation signal.

### ADVANTAGEOUS EFFECTS OF INVENTION

According to a resolver of the invention, it is possible to remove noise from an output signal to enhance detection accuracy even when noise resulting from the excitation signal is caused due to stray capacitance and electromagnetic induction in a harness.

### BRIEF DESCRIPTION OF DRAWINGS

FIG. 1 is a block diagram showing a configuration of a resolver in an embodiment;

FIG. 2 is a graph showing an ideal line and measured data;

FIG. 3 is a graph showing components of a noise waveform;

FIG. 4 is a table showing components of a cancel injection signal;

FIG. 5 is a view showing a cancel injection circuit of a transformer type in a first embodiment;

FIG. 6 is a view showing a cancel injection circuit of an adding type in a second embodiment;

FIG. 7 is a view showing a configuration of an adding circuit;

FIG. 8 is a view showing a configuration of an adding circuit in a modified example of the second embodiment; and

FIG. 9 is a table to explain switching operations of the adding circuit.

### DESCRIPTION OF EMBODIMENTS

A detailed description of a first preferred embodiment of the present invention will now be given referring to the accompanying drawings.

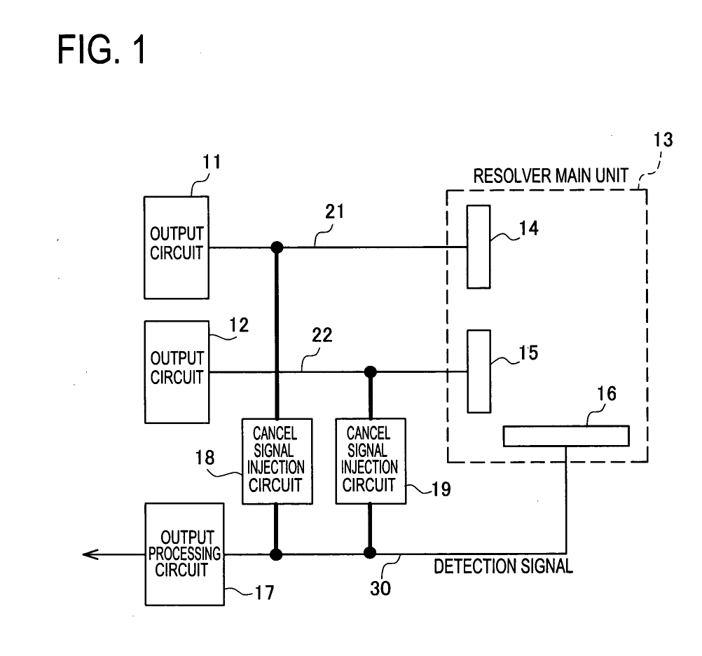

The configuration of the first embodiment embodying a resolver of the invention will be explained referring to FIG. 1. The resolver in this embodiment is a resolver of two phase excitation and one phase detection type. A resolver main unit 13 includes a sine wave coil 14, a cosine wave coil 15, and a search coil 16. The sine wave coil 14 is connected to an output circuit 11 for outputting an excitation signal including a sine wave. The cosine wave coil 15 is connected to an output circuit 12 for outputting an excitation signal including a cosine wave. The search coil 16 is connected to an output processing circuit 17.

The output circuit 11 is directly connected to the output processing circuit 17 through a cancel signal injection circuit 18. The output circuit 12 is directly connected to the output processing circuit 17 through a cancel signal injection circuit 19.

The cancel signal injection circuits 18 and 19 are explained below.

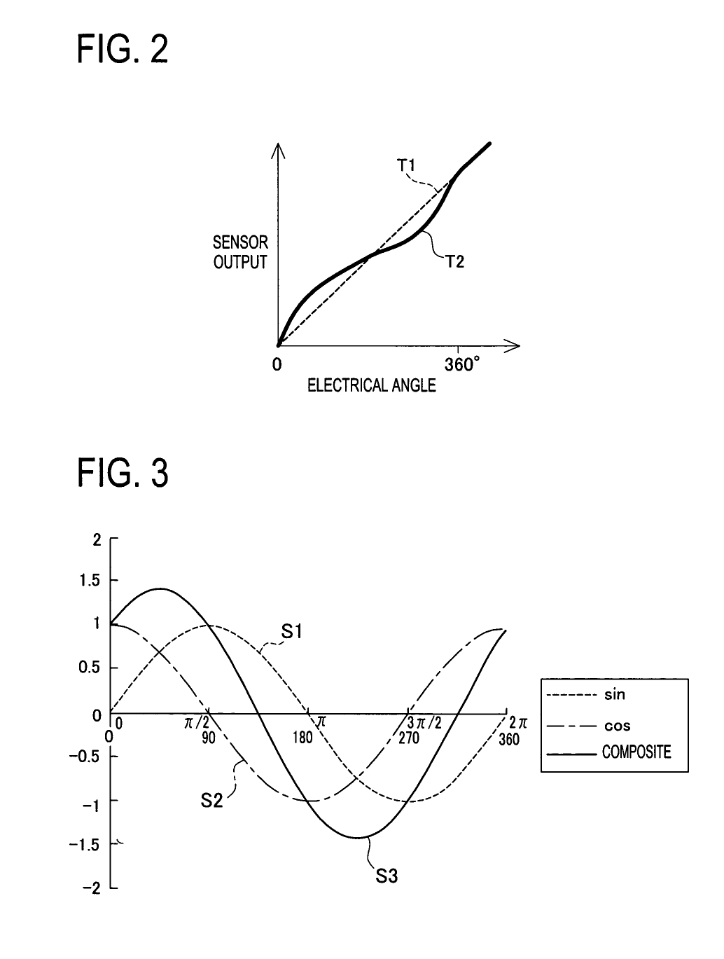

The measurement of noise is first explained. In a state where the cancel signal injection circuits 18 and 19 of FIG. 1 are not connected yet, noise is measured from an output signal input from the search coil 16 to the output processing circuit 17. A measurement result is shown in FIG. 2. In this graph, a vertical axis represents sensor output angles (output of the output processing circuit 17) of the resolver and a lateral axis represents actual electrical angles. If no noise occurs, data is as indicated by an ideal line T1. However, actually, nose is superimposed on the data due to stray capacitance in the circuit, electromagnetic inductance in a harness, and others. Thus, measured data is as indicated by a measured data line T2 depicted as a solid line in FIG. 2. A difference between the ideal line T1 and the measured data line T2 represents noise.

FIG. 3 shows a noise waveform S3 as an example of the noise waveform. This noise waveform S3 is considered as a composite waveform of a sine wave S1 and a cosine wave S2.

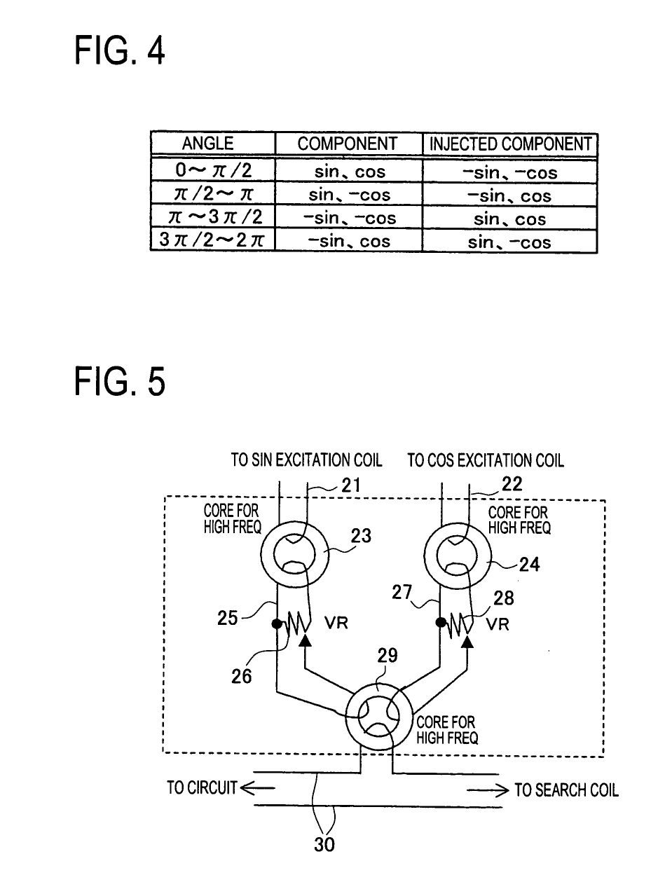

FIG. 4 is a table showing cancel signals to be injected in the cancel signal injection circuits 18 and 19.

In a case where a peak of the noise waveform is in a zone from zero to π/2, a composite of a component (SIN) of a sine wave excitation signal and a component (COS) of a cosine wave excitation signal results in noise. To cancel the noise, it is only necessary to inject a cancel signal having an opposite phase component (−SIN) of the sine wave excitation signal and an opposite phase component (−COS) of the cosine wave excitation signal.

In a case where a peak of the noise waveform is in a zone from π/2 to π, a composite of a component (SIN) of a sine wave excitation signal and an opposite phase component (−COS) of a cosine wave excitation signal results in noise. To cancel the noise, it is only necessary to inject a cancel signal having an opposite phase component (−SIN) of the sine wave excitation signal and a component (COS) of the cosine wave excitation signal.

In a case where a peak of the noise waveform is in a zone from π to 3π/2, a composite of an opposite phase component (−SIN) of a sine wave excitation signal and an opposite phase component (−COS) of a cosine wave excitation signal results in noise. To cancel the noise, it is only necessary to inject a cancel signal having a component (SIN) of the sine wave excitation signal and a component (COS) of the cosine wave excitation signal.

In a case where a peak of the noise waveform is in a zone from 3π/2 to 2π, a composite of an opposite phase component (−SIN) of a sine wave excitation signal and a component (COS) of a cosine wave excitation signal results in noise. To cancel the noise, it is only necessary to inject a cancel signal having a component (SIN) of the sine wave excitation signal and an opposite phase component (−COS) of the cosine wave excitation signal.

For instance, in a case where the noise waveform has a peak in the zone from zero to π/2, as shown in the example in FIG. 3, the noise signal has a composite waveform containing “SIN” and “COS” components. In this case, a cancel signal containing “−SIN” and “−COS” components having the opposite phase to “SIN” and “COS” is injected. Thus, the noise signal and the cancel signal cancel out each other, resulting in reduced noise.

A concrete example to actually generate the above cancel signals is explained below. FIG. 5 is a circuit configured using a transformer to embody the cancel signal injection circuits 18 and 19.

A connecting wire 21 connects the sine wave coil 14 and the excitation signal output circuit 11 and is wound on a part of a ferrite core 23 for high-frequency (hereinafter, high-frequency core). On another part (e.g., a diametrically opposite part) of the high-frequency core 23, one end of a connecting wire 25 is wound. The other end of the connecting wire 25 is wound on a part of a high-frequency core 29. A variable resistor 26 is connected to the connecting wire 25.

Similarly, a connecting wire 22 connects the cosine wave coil 15 and the output circuit 12 and is wound on a part of a ferrite core 24 for high-frequency (hereinafter, high-frequency core). On another part (e.g., a diametrically opposite part) of the high-frequency core 24, one end of a connecting wire 27 is wound. The other end of the connecting wire 27 is wound on a part of the high-frequency core 29. A variable resistor 28 is connected to the connecting wire 27.

Furthermore, one of a pair of output wires 30 is wound on another part of the high-frequency core 29. Specifically, the output wires 30 connect the search coil 16 and the output processing circuit 17. One of the output wires 30 is halfway wound on another part of the high-frequency core 29.

The high-frequency cores 23, 24, and 29, the connecting wires 21, 22, 25, and 27, the variable resistors 26 and 28, and the output wires 30 constitute the cancel signal injection circuits 18 and 19.

The characteristics of the cancel signal injection circuits 18 and 19 are determined based on the number of turns (winding turns) of each of the connecting wires 21, 22, 25, 27 and the output wires 30 on the high-frequency cores 23, 24, and 29 and resistance values of the variable resistors 26 and 28. Specifically, those values are previously determined based on the noise phase and noise level in FIG. 3, thereby constituting the cancel signal injection circuits 18 and 19 based on the determined number of turns, the winding direction, and resistance values.

Furthermore, each of the connecting wires 21, 22, 25, 27 is preferably configured as a twisted pair wire or a shielded wire to be more resistant to noise.

The resolver in the first embodiment, as explained in detail above, includes the excitation coils 14 and 15, the excitation signal output circuits 11 and 12 for outputting excitation signals to the excitation coils 14 and 15, the search coil 16 for receiving a magnetic field generated in the excitation coils 14 and 15, and the output signal processing circuit 17 for calculating the position of the search coil 16 by processing the detection signal detected by the search coil 16. This resolver further includes the cancel signal injection circuits 18 and 19 configured to combine the detection signal and the cancel signal generated by use of the excitation signal to have an opposite phase to the noise in order to remove the noise contained in the detection signal detected by the search coil 16. Accordingly, even when noise is caused in sync with the excitation signal due to stray capacitance, electromagnetic induction in the harness, and others, it is possible to remove the noise from the output signal, thereby enhancing detection accuracy.

The cancel signal injection circuits 18 and 19 include the high-frequency cores 23, 24, and 29 serving as transformers. This configuration can easily remove noise without needing any extra calculation circuit.

In particular, the excitation signals to be output from the excitation signal output circuits 11 and 12 are generated by amplitude modulation of high-frequency signals. Accordingly, much noise even if generated by high-frequency signals can be precisely removed. The detection accuracy can therefore be enhanced.

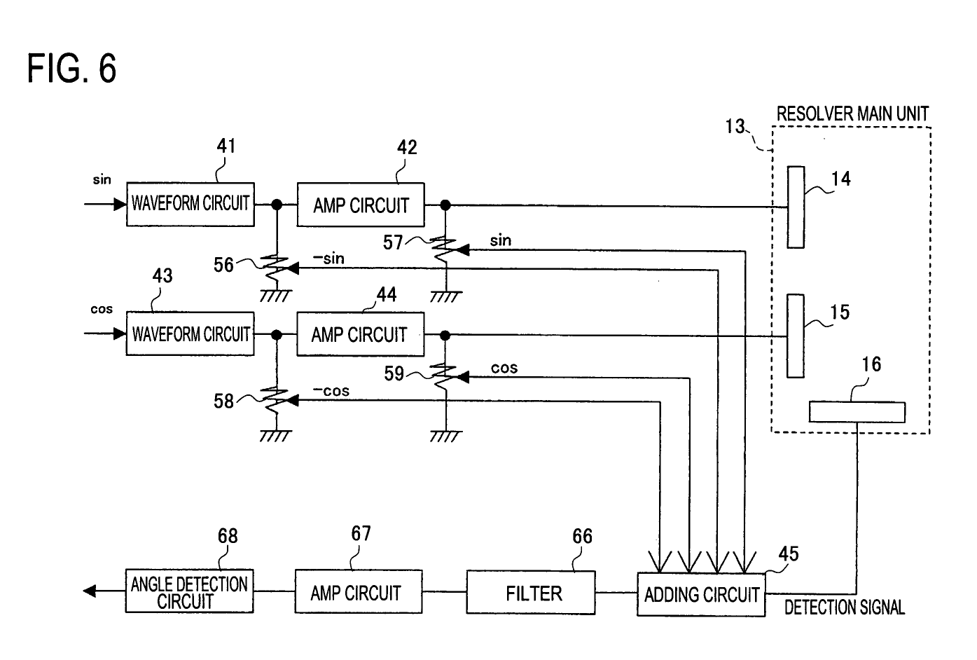

A second embodiment of the invention will be explained below. The second embodiment is different from the first embodiment in concrete configurations of the cancel signal injection circuits 18 and 19. The following explanation is thus focused on such difference referring to FIG. 6.

A resolver main unit 13 includes a sine wave coil 14, a cosine wave coil 15, and a search coil 16. A waveform circuit 41 serving as an output circuit to output a sine wave is connected to the sine wave coil 14 through an amplifier circuit 42 having the function of inverting the waveform. A connecting wire connecting the waveform circuit 41 and the amplifier circuit 42 is grounded through a variable resistor 56. A connecting wire connecting the amplifier circuit 42 and the sine wave coil 14 is grounded through a variable resistor 57.

A waveform circuit 43 serving as an output circuit to output a cosine wave is connected to the cosine wave coil 15 through an amplifier circuit 44 having the function of inverting the waveform. A connecting wire connecting the waveform circuit 43 and the amplifier circuit 44 is grounded through a variable resistor 58. A connecting wire connecting the amplifier circuit 44 and the cosine wave coil 15 is grounded through a variable resistor 59.

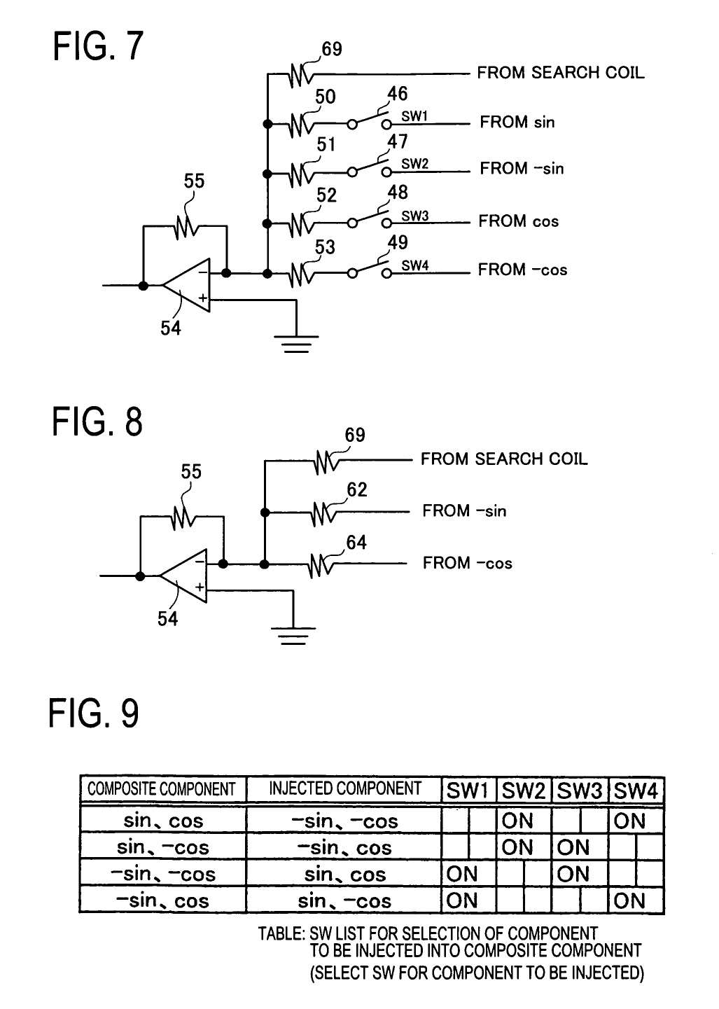

Movable terminals of the variable resistors 56 to 59 are connected to an adding circuit 45 respectively. The configuration of the adding circuit 45 is shown in FIG. 7. In the second embodiment, the adding circuit 45 acts as the cancel signal injection circuits 18 and 19.

The movable terminal of the variable resistor 57 is connected to a negative input terminal of an operational amplifier 54 through a switch 46 and a resistor 50. Similarly, the movable terminal of the variable resistor 56 is connected to the negative input terminal of the operational amplifier 54 through a switch 47 and a resistor 51. The movable terminal of the variable resistor 59 is connected to the negative input terminal of the operational amplifier 54 through a switch 48 and a resistor 52. The movable terminal of the variable resistor 58 is also connected to the negative input terminal of the operational amplifier 54 through a switch 49 and a resistor 53. The negative input terminal and an output terminal of the operational amplifier 54 are connected through a resistor 55. A positive terminal of the operational amplifier 54 is grounded.

On the other hand, as shown in FIG. 7, the search coil 16 is connected to the negative terminal of the operational amplifier 54 through a resistor 69. An output terminal of the adding circuit 45 is connected to an input terminal of a filter 66. An output terminal of the filter 66 is connected to an input terminal of an amplifier circuit 67. An output terminal of the amplifier circuit 67 is connected to an input terminal of an angle detection circuit 68.

The operation of the adding circuit 45 having the above configuration will be explained below. FIG. 9 is a table showing a method of selectively switching the switches 46 to 49. In order to cancel the noise component contained in the output of the search coil 16, as with the first embodiment, the switches 46 to 49 are selectively turned on/off as follows.

When the noise component is a composite of SIN and COS components, the switches 47 and 49 are turned on (closed) to inject −SIN and −COS components. When the noise component is a composite of SIN and −COS components, the switches 47 and 48 are turned on (closed) to inject −SIN and COS components. When the noise component is a composite of −SIN and −COS components, the switches 46 and 48 are turned on (closed) to inject SIN and COS components. When the noise component is a composite of −SIN and COS components, the switches 46 and 49 are turned on (closed) to inject SIN and −COS components. The above selecting operations of the switches are changed as needed.

The selected cancel components are added to the output of the search coil 16. Accordingly, the cancel component can cancel out the noise component included in the output of the search coil 16.

The characteristics of the adding circuit 45 acting as the cancel signal injection circuits 18 and 19 are determined based on the resistance values of the variable resistors 56 to 59 and the resistance values of the resistors 50 to 53 connected to the switches 46 to 49 respectively. Specifically, previously, those values are determined according to the noise contained in the output of the search coil 16 and the adding circuit 45 is constituted based on the determined resistance values.

In this embodiment, the variable resistor 56 and the resistor 51; the variable resistor 57 and the resistor 50; the variable resistor 58 and the resistor 53; and the variable resistor 59 and the resistor 52 are connected in series to each other in each combination. Alternatively, the resolver has only to include either the variable resistors or the resistors and the other is omissible. In other words, the resistors 50 to 53 or the variable resistors 56 to 59 may be omitted. In the case of omitting the variable resistors 56 to 59, each of outputs of the waveform circuit 41, the amplifier circuit 42, the waveform circuit 43, and the amplifier circuit 44 has to be directly input to the adding circuit 45.

FIG. 8 shows a modified example of the second embodiment. The modified example shown in FIG. 8 is substantially identical to the second embodiment. The following explanation is therefore focused on differences from the second embodiment without repeatedly explaining the identical parts or components. In FIG. 8, the resistors 50 to 53 and the switches 46 to 49 are not used.

Only terminals for the signal components required as injection components to cancel noise are connected to the negative terminal of the operational amplifier 54 through resistors 62 and 64. The example shown in FIG. 8 shows the injection of −SIN and −COS components. However, the injection components are changed according to the noise components.

The modified example shown in FIG. 8 provides reduction in the number of resistors and switches. Cost reduction is thus achieved. As with the case shown in FIG. 7, furthermore, the variable resistors may be omitted.

According to the resolver in the second embodiment, as explained in detail above, the switches 46 to 49, the resistors 50 to 53, the operational amplifier 54, and others are simply added to an already available circuit. This resolver can be produced at low cost. Furthermore, the resolver actually can measure noise components in a circuit and precisely inject a signal having the opposite phase to the measured noise components, thereby removing the noise components with high precision and enhancing the detection accuracy.

In particular, the excitation signals to be output from the excitation signal output circuits 11 and 12 are generated by amplitude modulation of the high-frequency signals. Accordingly, even if much noise is generated by high-frequency signals, such noise can be precisely removed. The detection accuracy can therefore be enhanced.

The above embodiment exemplifies the resolver of two phase excitation and one phase detection type. The present invention may be applied to a resolver of one phase excitation and two phase detection type. In this case, the excitation signal has a single phase. However, the opposite phase components of the excitation signal or the components of the excitation signal may be combined with (injected into) an output signal of the resolver in order to cancel the components of the excitation signal or the opposite phase components thereof contained as noise in the output signal of the resolver. It is to be noted that an example of a configuration to combine an excitation signal or an opposite phase signal and the output signal of the resolver to cancel noise, as with the example of the two-phase excitation and one-phase detection type resolver may use a high-frequency core and an adding circuit without limit thereto.

The present invention is explained in the above embodiments but not limited thereto. The invention also may be embodied in other specific forms without departing from the essential characteristics thereof.

For instance, in the above embodiment, the output of the high-frequency core 23 and the output of the high-frequency core 24 are merged in the high-frequency core 29. As an alternative, the high-frequency core 29 may be configured as two separate cores, one for receiving the output of the high-frequency core 23 and the other for receiving the output of the high-frequency core 24.

However, the use of the single high-frequency core 29 as in the above embodiments can achieve a reduction in the number of cores, contributing to cost reduction. The merging of outputs is more effective in preventing noise from reversely entering. In other words, if separate cores are provided to receive outputs of the high-frequency cores 23 and 24 respectively, when output wires from the separate cores are connected to the cores 23 and 24, the core 23 or 24 connected to one of the separate core may receive noise from the other core. In the above embodiments, such a problem is prevented by use of the single high-frequency core 29 as an output side core.

While the presently preferred embodiment of the present invention has been shown and described, it is to be understood that this disclosure is for the purpose of illustration and that various changes and modifications may be made without departing from the scope of the invention as set forth in the appended claims.

### REFERENCE SIGNS LIST

11, 12: Output circuit
13: Resolver main unit
14: Sine wave coil
15: Cosine wave coil
16: Search coil
17: Output processing circuit
18, 19: Cancel signal injection circuit
23, 24, 29: High-frequency circuit
45: Adding circuit
46, 47, 48, 49: Switch
54: Operational amplifier

1. A resolver including: an excitation coil; an excitation signal output circuit for outputting an excitation signal to the excitation coil; a search coil for receiving a magnetic field generated in the excitation coil; and a detection signal processing circuit for processing a detection signal detected by the search coil, the resolver comprising:
a noise cancel circuit configured to combine the detection signal and one of the excitation signal and a signal having an opposite phase to that of the excitation signal.

2. The resolver according to claim 1, wherein the noise cancel circuit includes a transformer.

3. The resolver according to claim 2, wherein
the excitation coil is two coils, one being a sine wave coil and the other being a cosine wave coil, and
the transformer includes three cores, one being a sine wave high-frequency core for the sine wave coil, another being a cosine wave high-frequency core for the cosine wave coil, and another being an output high-frequency core configured to simultaneously receive output of the sine wave high-frequency core and output of the cosine wave high-frequency core.

4. The resolver according to claim 1, wherein the noise cancel circuit includes an adding circuit.

5. The resolver according to claim 4, wherein the noise cancel circuit includes one of a switching circuit and a resistor, the switching circuit being configured to supply a predetermined sine wave component and a cosine wave component serving as a cancel signal to the adding circuit.

6. The resolver according to claim 1, wherein the excitation signal is generated by amplitude modulation of a high-frequency signal.

7. The resolver according to claim 2, wherein the excitation signal is generated by amplitude modulation of a high-frequency signal.

8. The resolver according to claim 3, wherein the excitation signal is generated by amplitude modulation of a high-frequency signal.

9. The resolver according to claim 4, wherein the excitation signal is generated by amplitude modulation of a high-frequency signal.

10. The resolver according to claim 5, wherein the excitation signal is generated by amplitude modulation of a high-frequency signal.
